(19) United States
(12) Patent Application Publication
(10) Pub. No.: US 2026/0261131 A1
(43) Pub. Date: Sep. 3, 2026

(54) POWER SYSTEM AND CONTROL METHOD THEREFOR

(71) Applicant: FUJI ELECTRIC CO., LTD., Kawasaki-shi (JP)

(72) Inventor: Takayuki NAGAKURA, Yokohama-city (JP)

(73) Assignee: FUJI ELECTRIC CO., LTD., Kawasaki-shi (JP)

(21) Appl. No.: 19/547,301

(22) Filed: Feb. 23, 2026

(30) Foreign Application Priority Data
Mar. 3, 2025 (JP) 2025-032885

(51) Int. Cl. H02J 3/38; G05B 13/04; H02J 101/24; H02J 101/28

(52) U.S. Cl. CPC H02J 3/381; G05B 13/042; H02J 2101/24; H02J 2101/28

(57) ABSTRACT

A power system includes a plurality of power generation systems capable of supplying power to a power grid, wherein each of the plurality of power generation systems includes a renewable-energy-power-generation facility configured to generate power using renewable energy and a power generation controller configured to control, so as to follow a characteristic curve representative of a relationship between a stability indicator relating to stability of grid power in the power grid and power to be generated by the renewable-energy-power-generation facility, the power to be generated by the renewable-energy-power-generation facility in accordance with the stability indicator, and wherein the power generation controller is configured to adjust the characteristic curve in a direction that causes an increase in the power to be generated in a case in which a supply of renewable energy to the renewable-energy-power-generation facility increases after an occurrence of fluctuation in the stability indicator.

### CROSS REFERENCE TO RELATED APPLICATION

This Application is based on, and claims priority from, Japanese Patent Application No. 2025-32885, filed on March 3, 2025, the entire contents of which are incorporated herein by reference.

### BACKGROUND

### Technical Field

This disclosure relates to techniques for controlling renewable energy power generation facilities.

### Related Art

There has been proposed in the art a power generation system in which a plurality of renewable energy power generation facilities, such as solar power generation facilities or wind power generation facilities, supplies power to a power grid. Power that is to be generated by the renewable energy power generation facilities is controlled in accordance with an indicator (hereinafter referred to as a “stability indicator”) relating to stability of power in the power grid. For example, Non-patent Document 1 (“Reflection in grid interconnection regulations,” Organization for Cross-regional Coordination of Transmission Operators, JAPAN, 17th grid code review meeting/material 6, July 31, 2024) discloses a technique for controlling active power, which is to be generated by renewable energy power generation facilities, in accordance with a frequency (hereinafter referred to as a “grid frequency”) of power in a power grid. In the technique disclosed in Non-patent Document 1, so as to follow an operation curve representative of a relationship between grid frequency and active power, power that is to be generated by the renewable energy power generation facilities is controlled in accordance with the grid frequency. However, for example, in a case in which a supply of renewable energy to a renewable energy power generation facility decreases, there is a possibility that an entire power system cannot supply sufficient power to a power grid even if power to be generated by the renewable energy power generation facility is controlled in response to an occurrence of fluctuation in a grid frequency.

### SUMMARY

In view of the circumstances described above, an object of an aspect of this disclosure is to reduce probability of a shortage of supply of power to a power grid in a case in which a supply of renewable energy fluctuates after occurrence of fluctuation in a stability indicator.

A power system according to an aspect of this disclosure includes a plurality of power generation systems capable of supplying power to a power grid, wherein each of the plurality of power generation systems includes a renewable energy power generation facility configured to generate power using renewable energy and a power generation controller configured to control, so as to follow a characteristic curve representative of a relationship between a stability indicator relating to stability of grid power in the power grid and power that is to be generated by the renewable energy power generation facility, the power that is to be generated by the renewable energy power generation facility in accordance with the stability indicator, and wherein the power generation controller is configured to adjust the characteristic curve in a direction that causes an increase in the power that is to be generated in a case in which a supply of renewable energy to the renewable energy power generation facility increases after an occurrence of fluctuation in the stability indicator.

A method for controlling a power system according to another aspect of this disclosure is a method for controlling a power system including a plurality of renewable energy generation facilities capable of supplying power generated by use of renewable energy to a power grid, the method including, for a renewable energy power generation facility that is any one of the plurality of renewable energy power generation facilities, controlling, so as to follow a characteristic curve representative of a relationship between a stability indicator relating to stability of grid power in the power grid and power that is to be generated by the renewable energy power generation facility, the power that is to be generated by the renewable energy power generation facility in accordance with the stability indicator, wherein the controlling the power that is to be generated includes adjusting the characteristic curve in a direction that causes an increase in the power that is to be generated in a case in which a supply of renewable energy to the renewable energy power generation facility increases after an occurrence of fluctuation in the stability indicator.

### BRIEF DESCRIPTION OF THE DRAWINGS

FIG. 1 is a block diagram showing an example of a configuration of a power system according to a first embodiment.

FIG. 2 is an explanatory diagram relating to control of a solar power generation facility by a power generation control apparatus.

FIG. 3 is a flowchart showing control processing.

FIG. 4 is an explanatory diagram showing a reduction in power that is to be generated by a power generation system receiving solar radiation that decreases among a plurality of power generation systems.

FIG. 5 is an explanatory diagram relating to setting an adjustment characteristic curve in a power generation system receiving solar radiation that increases among the plurality of power generation systems.

FIG. 6 is a block diagram showing an example of a configuration of a power system according to a second embodiment.

FIG. 7 is a block diagram showing an example of a configuration of a power system according to a third embodiment.

### DETAILED DESCRIPTION

Embodiments according to this disclosure will now be described with reference to the accompanying drawings. It should be noted that each of the embodiments described below is an exemplary embodiment assumed in a case in which this disclosure is implemented. Thus, the scope of this disclosure is not limited to the embodiments described below.

### First Embodiment

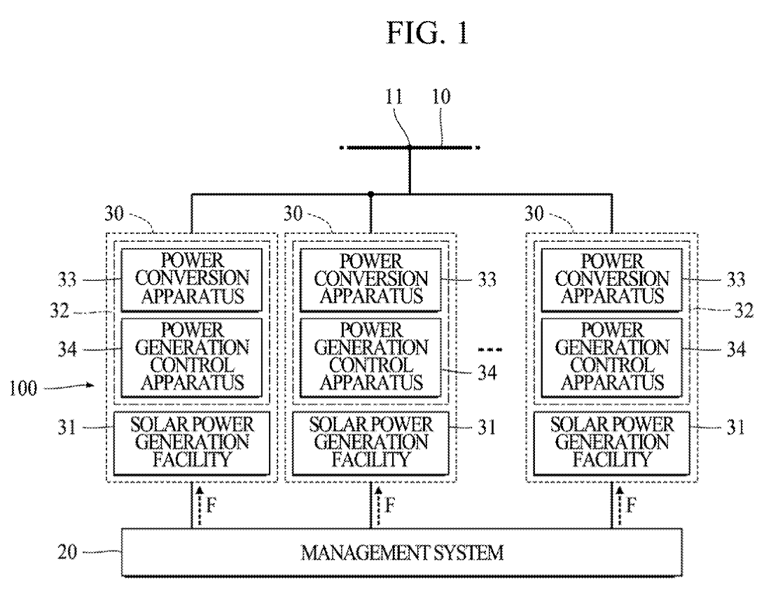

FIG. 1 is a block diagram showing an example of a configuration of a power system 100 according to a first embodiment. The power system 100 according to the first embodiment is a system capable of supplying alternating current (AC) power to a power grid 10. The power grid 10 is, for example, a power distribution system or a power transmission system configured to supply power generated by a power generation facility (not shown) such as a thermal power plant or a nuclear power plant to customers such as business facilities or typical homes.

As shown in FIG. 1, the power system 100 includes a management system 20 and a plurality of power generation systems 30. The management system 20 is a computer system (an energy management system: an EMS) configured to comprehensively manage power (hereinafter referred to as “grid power”) in the power grid 10. The management system 20 is, for example, a system managed by a power supplier operating the power grid 10. It should be noted that the management system 20 may be interpreted as a system external to the power system 100. In other words, the management system 20 is not essential to the power system 100.

Each of the plurality of power generation systems 30 is a power facility capable of supplying power to the power grid 10. The plurality of power generation systems 30 is connected to the power grid 10 at a grid connection point 11. Each of the plurality of power generation systems 30 is operated, for example, by a power producer supplying power to the power grid 10. It should be noted that both the management system 20 and each of the plurality of power generation systems 30 may be operated by the power producer. Each of the plurality of power generation systems 30 includes a solar power generation facility 31 and a control system 32.

The solar power generation facility 31 is a renewable energy power generation facility configured to generate power using solar energy that is renewable energy. The solar power generation facility 31 is constituted of a plurality of solar cell modules configured to generate direct current (DC) power by receiving sunlight, for example. Active power (hereinafter referred to as “power P”) that is to be generated by the solar power generation facility 31 varies depending on a supply of solar energy to the solar power generation facility 31. In the following description, as an example of the supply of solar energy to the solar power generation facility 31, an amount of solar radiation E may be given. The amount of solar radiation E is an amount of energy of sunlight received by the solar power generation facility 31.

The control system 32 is a power conditioning system (PCS) configured to control the solar power generation facility 31. The control system 32 includes a power conversion apparatus 33 and a power generation control apparatus 34. The power conversion apparatus 33 converts the DC power generated by the solar power generation facility 31 into AC power that is to be supplied to the power grid 10. It should be noted that a transformer (not shown) for changing voltage of the AC power is provided between the power conversion apparatus 33 and the power grid 10.

The power generation control apparatus 34 is a computer system configured to control power that is to be generated by the solar power generation facility 31. Specifically, the power generation control apparatus 34 can control the power P that is to be generated by the solar power generation facility 31. The power generation control apparatus 34 includes a controller (not shown) such as a programmable logic device (PLD) or a central processing unit (CPU), and a storage device (not shown) that stores a program that is to be executed by the controller and data that is to be used by the controller, for example. In addition, the power generation control apparatus 34 is communicable with the management system 20 via a communication line such as a dedicated line, for example. It should be noted that the power generation control apparatus 34 is an example of a “power generation controller.”

A frequency (hereinafter referred to as a “grid frequency F”) of the grid power in the power grid 10 varies depending on a relationship between supply and demand for the grid power. In each of the plurality of power generation systems 30, the power generation control apparatus 34 controls, in accordance with the grid frequency F, the power P that is to be generated by the solar power generation facility 31 such that fluctuation in the grid frequency F is substantially prevented (Frequency-Watt control). For the control described above, the management system 20 notifies the grid frequency F to the power generation control apparatus 34 of each of the plurality of power generation systems 30.

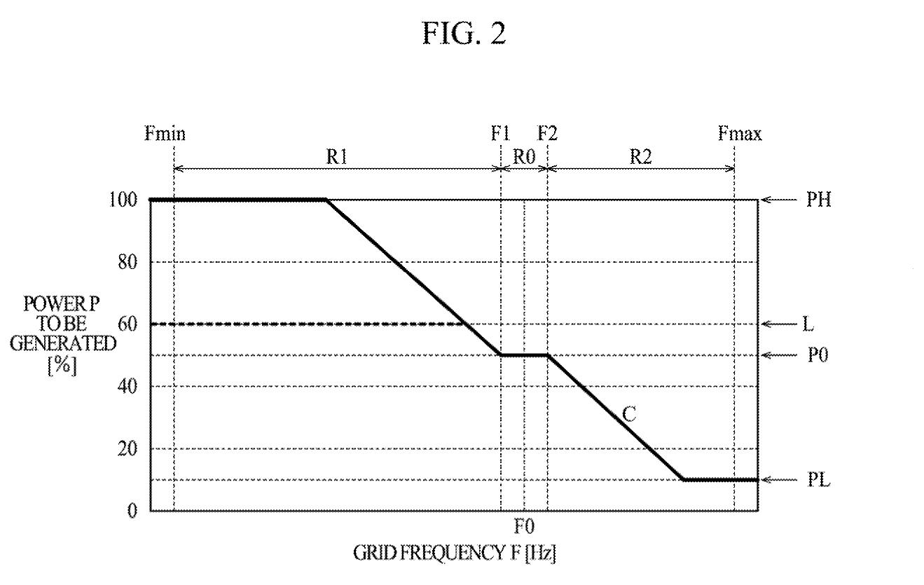

FIG. 2 is an explanatory diagram relating to control of the solar power generation facility 31 by the power generation control apparatus 34. In FIG. 2, a relationship (hereinafter referred to as a “characteristic curve C”) between the grid frequency F and the power P is shown. A horizontal axis in FIG. 2 represents the grid frequency F, and a vertical axis in FIG. 2 represents the power P. In FIG. 2, active power, which is a ratio of power that is to be actually output by the solar power generation facility 31 to rated power (maximum output) of the solar power generation facility 31, is shown as the power P.

When the grid power is insufficient due to the demand for the grid power being greater than the supply of the grid power, the grid frequency F decreases. On the other hand, when the grid power is excessive due to the supply of the grid power being greater than the demand for the grid power, the grid frequency F increases. In view of the trends described above, in general terms, the power generation control apparatus 34 controls the power P that is to be generated by the solar power generation facility 31 such that the power P is reduced with an increase in the grid frequency F and the power P is increased with a decrease in the grid frequency F. Specifically, the power generation control apparatus 34 controls the power P so as to follow the characteristic curve C that is defined to correspond to the tends described above. The characteristic curve C is a line chart or a curved line representative of the relationship between the grid frequency F of the grid power and the power P that is to be generated by the solar power generation facility 31.

As shown in FIG. 2, a numerical range of grid frequencies F is divided into a normal range R0, a first range R1, and a second range R2. The normal range R0 is a range including a reference value F0 of the grid frequency F. The reference value F0 is a target value of the grid frequency F (West Japan: 60 Hz; East Japan: 50 Hz). The normal range R0 is a range of a frequency F1 or more and a frequency F2 or less. The frequency F1 is a frequency less than the reference value F0 by a predetermined value (for example, 0.2 Hz), and the frequency F2 is a frequency greater than the reference value F0 by a predetermined value (for example, 0.2 Hz).

In the normal range R0, the characteristic curve C specifies a predetermined power (hereinafter referred to as “reference power P0”) as the power P. The reference power P0 is a power value that is independent of the grid frequency F. In other words, the normal range R0 is a dead band in which the power P is independent of the grid frequency F. Thus, the power P is maintained at the reference power P0 that is constant even when the grid frequency F fluctuates within the normal range R0. The reference power P0 is notified by the management system 20 to each of the plurality of power generation systems 30 in accordance with a preset power plan, for example. Thus, the reference power P0 may vary depending on the power plan at intervals of a predetermined period (for example, 30 minutes). The characteristic curve C is moved in a direction along the axis of the power P (a direction along the vertical axis) in accordance with the reference power P0.

The first range R1 is a range of grid frequencies F less than the normal range R0. In other words, the first range R1 corresponds to a state in which grid power is insufficient. Specifically, a range less than the frequency F1 that is a lower limit of the normal range R0 is set as the first range R1. For example, the first range R1 is a range between a minimum Fmin (Fmin < F1) of the grid frequency F and the frequency F1. It should be noted that the frequency F1 may be any numerical value within the normal range R0 and the first range R1.

In the first range R1, the characteristic curve C specifies a relationship in which the power P is increased with a decrease in the grid frequency F. In other words, in a part of the characteristic curve C within the first range R1, the power P increases from the reference power P0 toward a maximum PH (for example, 100%) as the grid frequency F decreases from the frequency F1. The maximum PH is a maximum value (for example, rated power) of the power P that is to be generated by the solar power generation facility 31. A ratio of change of the power P to the grid frequency F (a gradient) corresponds to a preset frequency regulation.

The second range R2 is a range of grid frequencies F greater than the normal range R0. In other words, the second range R2 corresponds to a state in which grid power is excessive. Specifically, a range greater than the frequency F2 that is an upper limit of the normal range R0 is set as the second range R2. For example, the second range R2 is a range between a maximum Fmax (Fmax > F2) of the grid frequency F and the frequency F2. It should be noted that the frequency F2 may be any numerical value within the normal range R0 and the first range R1.

In the second range R2, the characteristic curve C specifies a relationship in which the power P is reduced with an increase in the grid frequency F. In other words, in a part of the characteristic curve C within the second range R2, the power P is reduced from the reference power P0 toward a minimum PL (for example, 10%) as the grid frequency F increases from the frequency F2. The minimum PL is a minimum value of the power P that is to be generated by the solar power generation facility 31. A ratio of change of the power P to the grid frequency F (a gradient) corresponds to a preset frequency regulation.

The power generation control apparatus 34 controls the power P, which is to be generated by the solar power generation facility 31, in accordance with the grid frequency F so as to follow the characteristic curve C described above. Specifically, the power generation control apparatus 34 uses the characteristic curve C to determine power P corresponding to the grid frequency F notified by the management system 20, and controls the solar power generation facility 31 to cause the determined power P to be generated. However, when the grid frequency F is a numerical value within the first range R1, the power generation control apparatus 34 controls the power P in a state in which power L greater than the reference power P0 by a predetermined increment is used as an upper limit, as shown in dashed line in FIG. 2.

As described above, in the first embodiment, the power P that is to be generated by the solar power generation facility 31 of each of the plurality of power generation systems 30 is controlled in accordance with the grid frequency F so as to follow the characteristic curve C. Thus, it is possible to control the solar power generation facility 31 of each of the plurality of power generation systems 30 such that fluctuation in the grid frequency F is substantially prevented.

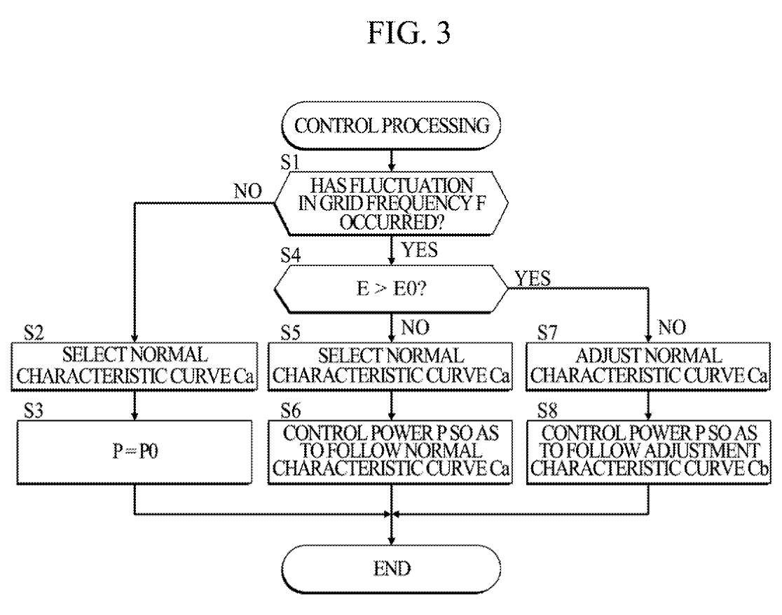

FIG. 3 is a flowchart showing an example of a processing procedure (hereinafter referred to as “control processing”) that is to be executed by the power generation control apparatus 34 so as to control the solar power generation facility 31. For example, the control processing starts each time the grid frequency F is notified by the management system 20. In other words, the control processing shown in FIG. 3 is executed repeatedly.

When the control processing starts, the power generation control apparatus 34 determines whether a fluctuation in the grid frequency F has occurred (S1). Specifically, the power generation control apparatus 34 determines whether the grid frequency F is a numerical value that is not within the normal range R0. In other words, when the grid frequency F is a numerical value that is within the normal range R0, the power generation control apparatus 34 determines that no fluctuation in the grid frequency F has occurred (S1: NO); on the other hand, when the grid frequency F is a numerical value that is within the first range R1 or within the second range R2, the power generation control apparatus 34 determines that a fluctuation in the grid frequency F has occurred (S1: YES).

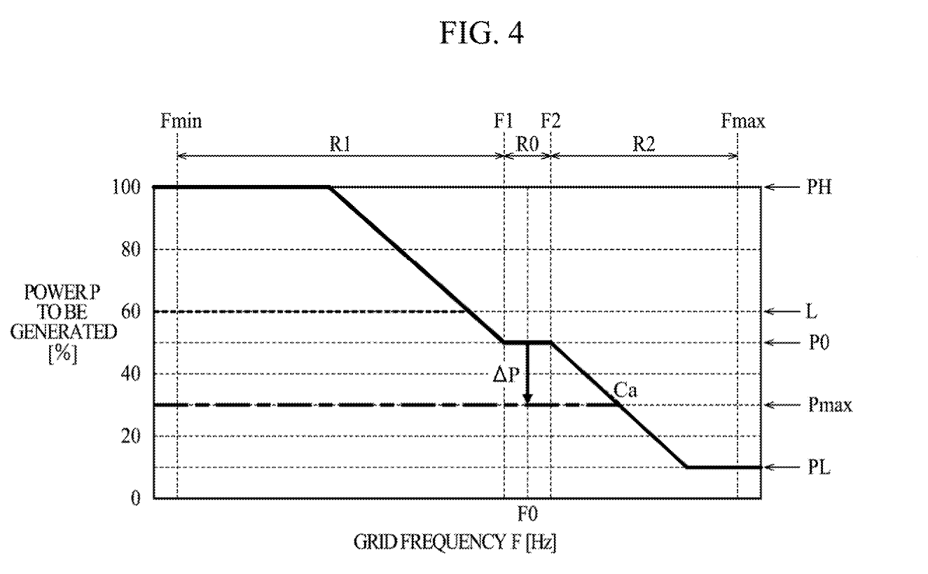

When no fluctuation in the grid frequency F has occurred (S1: NO), the power generation control apparatus 34 selects a normal characteristic curve C (hereinafter referred to as “normal characteristic curve Ca”) (S2). As shown in FIG. 4, the normal characteristic curve Ca is a normal characteristic curve C in which the reference power P0 within the normal range R0 is set to a value notified by the management system 20. The grid frequency F is a numerical value within the normal range R0 at this time (S1: NO); thus, the power generation control apparatus 34 sets the power P to the reference power P0 specified by the normal characteristic curve Ca (S3).

In a case in which a fluctuation in the grid frequency F has occurred (S1: YES), the power generation control apparatus 34 determines whether a current amount of solar radiation E received by the solar power generation facility 31 is greater than a reference value E0 (S4). The reference value E0 is, for example, an amount of solar radiation E at a point in time immediately before the fluctuation in the grid frequency F occurs. The current amount of solar radiation E is notified by the solar power generation facility 31 to the power generation control apparatus 34. It should be noted that in a case in which the current amount of solar radiation E is equal to the reference value E0, a result of determination in step S4 may be affirmative or negative.

When the current amount of solar radiation E is less than the reference value E0 (S4: N0), the power generation control apparatus 34 selects the normal characteristic curve Ca (S5). As described above, the normal characteristic curve Ca is a normal characteristic curve C in which the reference power P0 within the normal range R0 is set to the value notified by the management system 20. The power generation control apparatus 34 controls the power P so as to follow the normal characteristic curve Ca (S6). Specifically, the power generation control apparatus 34 uses the normal characteristic curve Ca to determine power P corresponding to the grid frequency F, and controls the solar power generation facility 31 to cause the determined power P to be supplied.

For example, as will be understood from FIG. 4, when the grid frequency F is a numerical value within the first range R1, the power P that is to be generated by the solar power generation facility 31 is set to a numerical value greater than the reference power P0 in a state in which the maximum PH is used as an upper limit. However, as shown in dashed line in FIG. 4, the power P is controlled in a state in which the power L greater than the reference power P0 of the normal characteristic curve Ca by a predetermined increment is used as an upper limit. On the other hand, when the grid frequency F is a numerical value within the second range R2, the power P that is to be generated by the solar power generation facility 31 is set to a numerical value less than the reference power P0 in a state in which the minimum PL is used as a lower limit.

However, the amount of solar radiation E received by the solar power generation facility 31 varies depending on the weather or the time from moment to moment, for example. When the amount of solar radiation E received by the solar power generation facility 31 decreases, there is a possibility that the solar power generation facility 31 cannot generate the power P so as to follow the normal characteristic curve Ca. For example, FIG. 4 shows, in long-dash and short-dash line, a state in which the power P is limited to a maximum Pmax due to a decrease in the amount of solar radiation E received by the solar power generation facility 31. The maximum Pmax of the power P is less than the reference power P0 of the normal characteristic curve Ca. A reduction ΔP in the power P due to a decrease in the amount of solar radiation E is a difference (ΔP = P0 − Pmax) between the reference power P0 and the maximum Pmax.

Locations of the power generation systems 30 constituting the power system 100 differ; thus, a state of solar radiation received by the solar power generation facility 31 of each of the power generation systems 30 differs among the power generation systems 30. Consequently, the plurality of power generation systems 30 constituting the power system 100 includes a power generation system 30 that includes a solar power generation facility 31 receiving solar radiation E that decreases, and a power generation system 30 that includes a solar power generation facility 31 receiving solar radiation E that increases. In view of the circumstances described above, the power generation control apparatus 34 according to the first embodiment supplements a shortage of power P that is to be generated by one or more power generation systems 30 (hereinafter referred to as “power generation systems 30[−]”) receiving solar radiation E that decreases among the plurality of power generation systems 30 with an increase in power P that is to be generated by one or more power generation systems 30 (hereinafter referred to as “power generation systems 30[+]”) receiving solar radiation E that increases among the plurality of power generation systems 30.

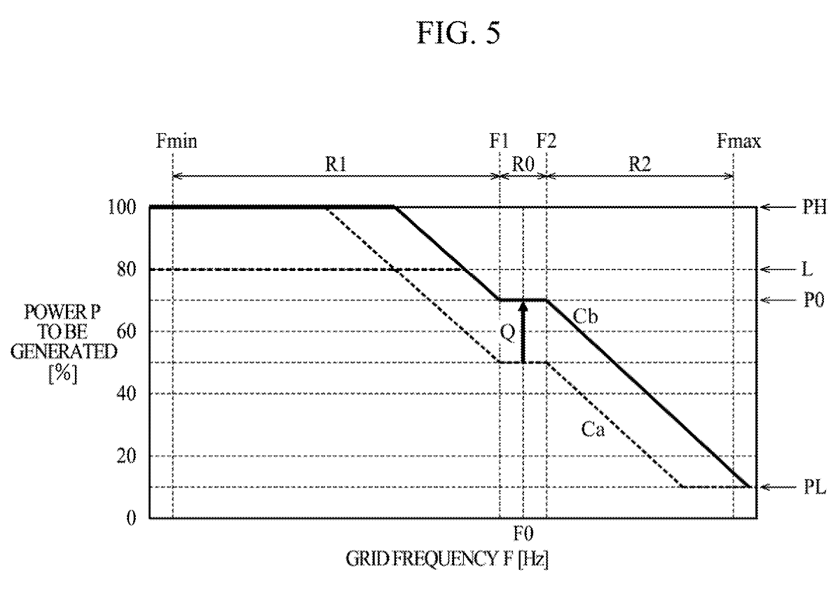

Specifically, when the current amount of solar radiation E is greater than the reference value E0 (S4: YES) after an occurrence of fluctuation in the grid frequency F (S1: YES), the power generation control apparatus 34 adjusts the normal characteristic curve Ca in a direction that causes an increase in the power P that is to be generated (S7), as shown in FIG. 5. Specifically, the power generation control apparatus 34 moves the normal characteristic curve Ca in the direction that causes an increase in the power P that is to be generated by an adjustment amount Q to set an adjusted characteristic curve C (hereinafter referred to as an “adjustment characteristic curve Cb”). In other words, the adjustment characteristic curve Cb is set by adding the adjustment amount Q to the normal characteristic curve Ca. It should be noted that an upper limit value of the adjustment characteristic curve Cb is limited to the maximum PH of the power P.

The adjustment amount Q, which is used to generate the adjustment characteristic curve Cb, is set to a numerical value corresponding to an amount of increase ΔE (ΔE = E − E0) in an amount of solar radiation E. For example, the adjustment amount Q may be a numerical value obtained by multiplying the amount of increase ΔE in an amount of solar radiation E by a predetermined coefficient. As described above, when the amount of solar radiation E increases (S4: YES) after the occurrence of the fluctuation in the grid frequency F (S1: YES), the characteristic curve C that is used to control the power P is changed from the normal characteristic curve Ca to the adjustment characteristic curve Cb.

The power generation control apparatus 34 controls the power P so as to follow the adjustment characteristic curve Cb (S8). Specifically, the power generation control apparatus 34 uses the adjustment characteristic curve Cb to determine power P corresponding to the grid frequency F, and controls the solar power generation facility 31 to cause the determined power P to be supplied. However, as shown in dashed line in FIG. 5, the power P is controlled in a state in which power L greater than a reference power P0 of the adjustment characteristic curve Cb by a predetermined increment is used as an upper limit.

The specific procedure of the control processing is as described above. When an amount of solar radiation E changes to being less than the reference value E0 in a state in which the adjustment characteristic curve Cb is used (S4: NO), the characteristic curve C that is used to control the power P is changed from the adjustment characteristic curve Cb to the normal characteristic curve Ca (S5). On the other hand, when the grid frequency F returns to a numerical value within the normal range R0 in a state in which the adjustment characteristic curve Cb is used (S1: NO), the characteristic curve C that is used to control the power P is changed from the adjustment characteristic curve Cb to the normal characteristic curve Ca (S2).

As will be understood from the above explanation, power P corresponding to a specific grid frequency F in the adjustment characteristic curve Cb is greater than power P corresponding to the specific grid frequency F in the normal characteristic curve Ca. According to the configuration described above, a shortage of power P that is to be generated by the one or more power generation systems 30[−] receiving solar radiation E that decreases among the plurality of power generation systems 30 is supplemented with an increase in power P that is to be generated by the one or more power generation systems 30[+] receiving solar radiation E that increases among the plurality of power generation systems 30. Thus, in the entire power system 100 constituted of the plurality of power generation systems 30, it is possible to reduce the probability of a shortage of power that is used to substantially prevent fluctuation in grid frequency F.

In addition, in the first embodiment, the normal characteristic curve Ca is adjusted in the direction that causes an increase in the power P by the adjustment amount Q corresponding to the amount of increase ΔE in an amount of solar radiation E. Thus, it is possible to reduce the probability that the characteristic curve C is excessively adjusted.

It should be noted that in the solar power generation facility 31 that uses solar energy, a supply of solar energy (for example, an amount of solar radiation E) is likely to change depending on factors such as the weather or the time, for example. Thus, the first embodiment that can reduce a shortage of power in the entire power system 100 by adjusting the characteristic curve C is particularly effective since the solar power generation facility 31 is used in the first embodiment.

### Second Embodiment

A second embodiment according to this disclosure will be described. It should be noted that in the descriptions of the following embodiments, elements having the same functions as in the first embodiment are denoted by the same reference numerals as used for like elements in the description of the first embodiment, and detailed description thereof is omitted, as appropriate.

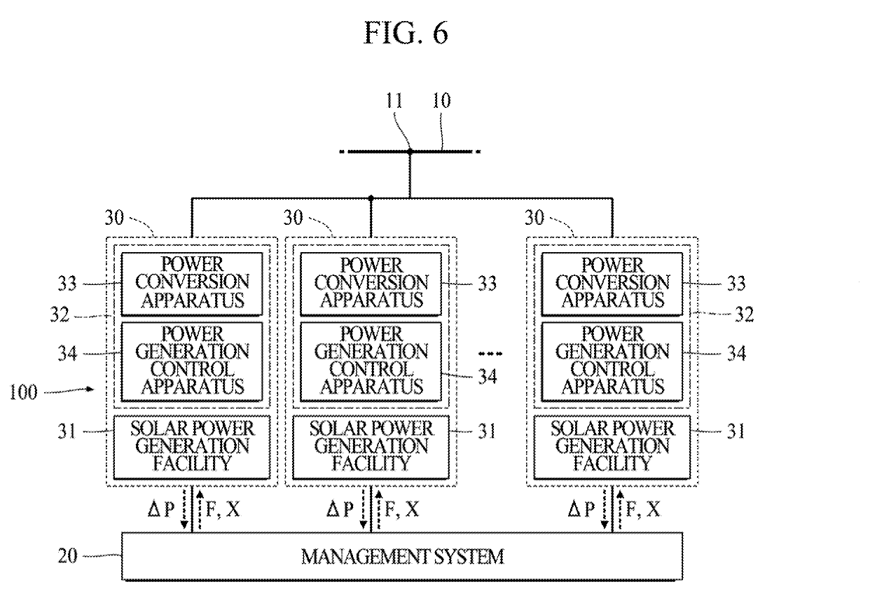

FIG. 6 is a block diagram showing an example of a configuration of a power system 100 according to the second embodiment. As shown in FIG. 6, a power generation control apparatus 34 of each of the power generation systems 30[−] receiving solar radiation E that decreases among the plurality of power generation systems 30 notifies the management system 20 of a reduction ΔP (ΔP = P0 − Pmax) in the power P due to a decrease in the amount of solar radiation E after an occurrence of fluctuation in the grid frequency F. In other words, the reduction ΔP in the power P due to the decrease in the amount of solar radiation E is gathered from each of the power generation systems 30 by the management system 20.

The management system 20 transmits a setting adjustment instruction X to a power generation control apparatus 34 of each of the power generation systems 30[+] receiving solar radiation E that increases among the plurality of power generation systems 30. The setting adjustment instruction X specifies an adjustment amount Q that is to be used to adjust the normal characteristic curve Ca (to set the adjustment characteristic curve Cb). In the setting of the adjustment characteristic curve Cb (S7), a power generation control apparatus 34 of each of the power generation systems 30[+] receiving solar radiation E that increases among the plurality of power generation systems 30 adjusts the normal characteristic curve Ca in the direction that causes an increase in the power P by the adjustment amount Q specified by the setting adjustment instruction X.

The management system 20 sets the adjustment amount Q, which is to be provided to each of the power generation systems 30[+] receiving solar radiation E that increases, in accordance with reductions ΔP in power P notified by the respective power generation systems 30. Specifically, the management system 20 calculates a total amount ΔPsum obtained by adding up reductions ΔP notified by the respective power generation systems 30[−] to set the adjustment amount Q in accordance with the total amount ΔPsum. For example, the adjustment amount Q is calculated by dividing the total amount ΔPsum by the total number N[+] of power generation systems 30[+] receiving solar radiation E that increases. Thus, the adjustment amount Q provided to each of the power generation systems 30[+] among the plurality of power generation systems 30 is less than the total amount ΔPsum of the reductions ΔP.

The total amount ΔPsum corresponds to a shortage of power that is to be supplied by all the plurality of power generation systems 30 to the power grid 10, the shortage being caused by a decrease in an amount of solar radiation E received by the one or more power generation systems 30[−]. On the other hand, the adjustment amount Q corresponds to an amount obtained by dividing the total amount ΔPsum, the amount being assigned to each of the power generation systems 30[+] receiving solar radiation E that increases. Thus, the adjustment amount Q is set to a greater numerical value as the total amount ΔPsum is greater, and the adjustment amount Q is set to a greater numerical value as the total number N[+] of power generation systems 30[+] is less.

As described above, the power generation control apparatus 34 according to the second embodiment adjusts the normal characteristic curve Ca in the direction that causes an increase in the power P by the adjustment amount Q less than the total amount ΔPsum. As described above, the total amount ΔPsum is a numerical value obtained by adding up the reductions ΔP in power P to be generated by the one or more power generation systems 30[−] receiving solar radiation E that decreases after occurrence of fluctuation in the grid frequency F.

The second embodiment provides the same effects as those provided by the first embodiment. Furthermore, in the second embodiment, the adjustment characteristic curve Cb is set within a range up to the total amount ΔPsum obtained by adding up the reductions ΔP in power P to be generated by the power generation systems 30[−] receiving solar radiation E that decreases. Thus, it is possible to reduce the probability that power supplied by the entire power system 100 to the power grid 10 will be excessive. In other words, the entire power system 100 can effectively reduce effects of fluctuation in amount of solar radiation E received by a specific power generation system 30.

### Third Embodiment

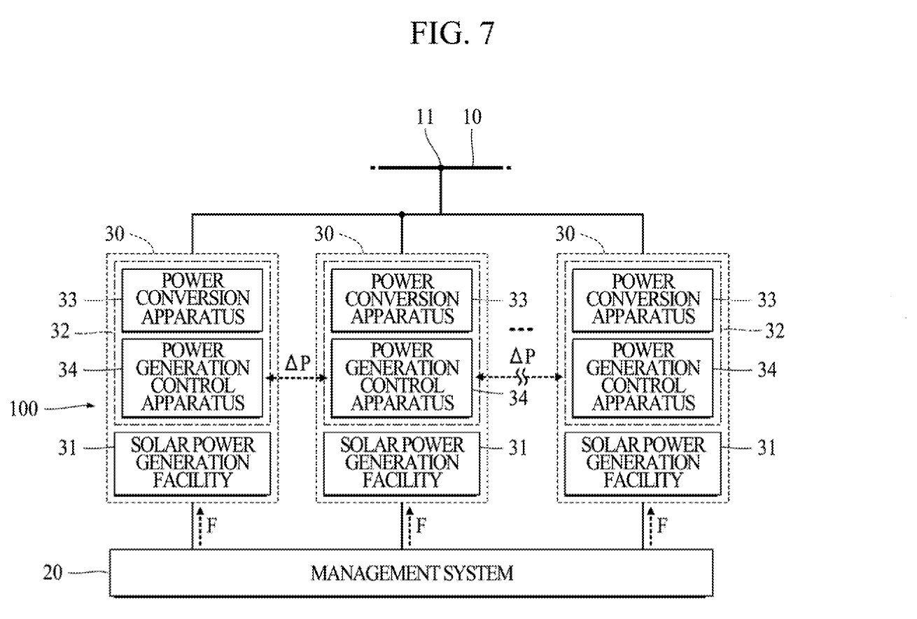

FIG. 7 is a block diagram showing an example of a configuration of a power system 100 according to a third embodiment. As shown in FIG. 7, in the third embodiment, power generation control apparatuses 34 of the power generation systems 30 can communicate with one another. Specifically, the power generation control apparatuses 34 can communicate with one another via a communication line such as a dedicated line, for example.

In the second embodiment described above, the power generation control apparatus 34 of each of the power generation systems 30[−] receiving solar radiation E that decreases among the plurality of power generation systems 30 notifies the reduction ΔP (ΔP = P0 − Pmax) in the power P to the management system 20. In the third embodiment, the power generation control apparatus 34 of each of the power generation systems 30[−] receiving solar radiation E that decreases notifies the reduction ΔP in the power P to power generation systems 30 other than the power generation system 30 including the power generation control apparatus 34 among the plurality of power generation systems 30. In other words, the reduction ΔP in the power P that is to be generated by each of the power generation systems 30[−] is shared by each of the plurality of power generation systems 30.

In the setting of the adjustment characteristic curve Cb (S7), a power generation control apparatus 34 of each of the power generation systems 30[+] receiving solar radiation E that increases among the plurality of power generation systems 30 adjusts the normal characteristic curve Ca in the direction that causes an increase in the power P by an adjustment amount Q corresponding to reductions ΔP in power P notified by other power generation systems 30. Specifically, the power generation control apparatus 34 calculates a total amount ΔPsum obtained by adding up the reductions ΔP notified by the respective power generation systems 30[−] to set the adjustment amount Q in accordance with the total amount ΔPsum. For example, the power generation control apparatus 34 sets the adjustment amount Q to a greater numerical value as the total amount ΔPsum is greater. In addition, the power generation control apparatus 34 counts the total number N[−] of power generation systems 30[−] that notified the reductions ΔP, and sets the adjustment amount Q in accordance with the total number N[−]. For example, the power generation control apparatus 34 sets the adjustment amount Q to a greater numerical value as the total number N[−] of power generation systems 30[−] is greater. The adjustment amount Q that is set by the power generation control apparatus 34 of each of the power generation systems 30[+] is less than the total amount ΔPsum of the reductions ΔP.

In the setting of the adjustment characteristic curve Cb (S7), the power generation control apparatus 34 of each of the power generation systems 30[+] receiving solar radiation E that increases among the plurality of power generation systems 30 adjusts the normal characteristic curve Ca in the direction that causes an increase in the power P by the adjustment amount Q that is set by the procedure described above.

It should be noted that the total number N of power generation systems 30 constituting the power system 100 is known; thus, the power generation control apparatus 34 can calculate the total number N[+] of power generation systems 30[+] by subtracting the total number N[−] of power generation systems 30[−] from the total number N. The power generation control apparatus 34 may set the adjustment amount Q in accordance with the total number N[+] of power generation systems 30[+]. For example, the power generation control apparatus 34 may set the adjustment amount Q to a smaller number as the total number N[+] of power generation systems 30[+] is greater. In addition, the power generation control apparatus 34 may calculate the adjustment amount Q by dividing the total amount ΔPsum of the reductions ΔP by the total number N[+] of power generation systems 30[+].

The third embodiment provides the same effects as those provided by the first embodiment. Furthermore, in the third embodiment, the adjustment characteristic curve Cb is set within a range up to the total amount ΔPsum obtained by adding up the reductions ΔP in power P to be generated by the power generation systems 30[−] receiving solar radiation E that decreases. Thus, it is possible to reduce the probability that power supplied by the entire power system 100 to the power grid 10 will be excessive. In other words, similar to the second embodiment, the entire power system 100 can effectively reduce effects of fluctuation in amount of solar radiation E received by a specific power generation system 30.

Furthermore, in contrast to the second embodiment, in the third embodiment, the reduction ΔP in the power P that is to be generated by each of the power generation systems 30[−] among the plurality of power generation systems 30 is shared by each of the plurality of power generation systems 30. Thus, compared to the second embodiment, the third embodiment has an advantage in that the management system 20, which is configured to manage each of the plurality of power generation systems 30 comprehensively, is not required to set the adjustment amount Q.

It should be noted that in contrast to the third embodiment, in the second embodiment, the reduction ΔP in the power P that is to be generated by each of the one or more power generation systems 30[−] among the plurality of power generation systems 30 is gathered by the management system 20. According to the configuration described above, a power generation control apparatus 34 of each of the plurality of power generation systems 30 is not required to recognize a reduction ΔP of power P that is to be generated by another power generation system 30. Thus, compared to the third embodiment, the second embodiment has an advantage in that it is possible to reduce load of processing executed by the power generation control apparatus 34 of each of the plurality of power generation systems 30.

### Modifications

Examples of specific modifications that may be added to the above embodiments will be described below. Two or more modifications freely selected from the following modifications may be appropriately combined as long as no conflict arises from such combination.

(1) In each of the above-described embodiments, when the grid frequency F is a numerical value within the first range R1, the power P is controlled in a state in which the power L greater than the reference power P0 by a predetermined increment is used as an upper limit; however, the limit of the power L may be omitted. In other words, when the grid frequency F is a numerical value within the first range R1, the power generation control apparatus 34 may set the power P, which is within a range from the reference power P0 to the maximum PH, in accordance with the grid frequency.

(2) In each of the above-described embodiments, the power P that is to be generated by the solar power generation facility 31 of each of the plurality of power generation systems 30 is controlled in accordance with the grid frequency F of the grid power (Frequency-Watt control); however, a parameter that is used to control the power P is not limited to the grid frequency F. For example, the power generation control apparatus 34 of each of the plurality of power generation systems 30 may control the power P, which is to be generated by a corresponding solar power generation facility 31, in accordance with voltage (hereinafter referred to as “grid voltage V”) of the grid power (Volt-Watt control).

For example, when the grid power is insufficient due to the demand for the grid power being greater than the supply of the grid power, the grid voltage V decreases. On the other hand, when the grid power is excessive due to the supply of the grid power being greater than the demand for the grid power, the grid voltage V increases. In view of the trends described above, the power generation control apparatus 34 controls, in accordance with the grid voltage V, the power P that is to be generated by the solar power generation facility 31 such that the power P is reduced with an increase in the grid voltage V and the power P is increased with a decrease in the grid voltage V. A relationship between power P and grid voltage V is similar to the relationship (FIG. 2) between power P and grid frequency F. In addition, an operation in which when the amount of solar radiation E increases (S4: YES) after an occurrence of fluctuation in the grid voltage V (S1: YES), the characteristic curve C that is used to control the power P is changed from the normal characteristic curve Ca to the adjustment characteristic curve Cb, is also the same as that of each of the above-described embodiments.

The grid frequency F and the grid voltage V are comprehensively described as an indicator (hereinafter referred to as a “stability indicator”) relating to stability of grid power. The stability indicator may be described as an indicator relating to quality of grid power or as an indicator relating to balance between supply and demand for grid power. The characteristic curve C in each of the above-described embodiments is comprehensively described as a curve representative of a relationship between the stability indicator and power P that is to be generated.

(3) In the above-described embodiments, a configuration is described in which the power generation system 30 includes the solar power generation facility 31; however, a target for being controlled by the power generation control apparatus 34 is not limited to the solar power generation facility 31. In other words, this disclosure can be used to control a freely selected type of renewable energy power generation facility capable of generating power using renewable energy. In the above-described embodiments, an amount of solar radiation E is given as an example of a supply of renewable energy to the solar power generation facility 31 (hereinafter referred to as “a supply of renewable energy”); however, the supply of renewable energy may be replaced with a parameter corresponding to a type of power generation method used by a renewable energy power generation facility.

For example, a wind power generation facility configured to generate power using wind energy as renewable energy may be controlled by the power generation control apparatus 34. A supply of renewable energy for controlling the wind power generation facility is an amount of wind energy, for example. For example, in the setting of the adjustment characteristic curve Cb (S7), a power controller adjusts the normal characteristic curve Ca to set the adjustment characteristic curve Cb when the wind energy increases after an occurrence of fluctuation in the grid frequency F.

In the wind power generation facility using wind power as renewable energy, a supply of renewable energy (for example, an amount of wind energy) is likely to change. Thus, this disclosure, by which the characteristic curve C is adjusted so as to reduce a shortage of power that is to be generated by the entire power system 100, is particularly effective in a configuration in which the wind power generation facility is used.

A geothermal power generation facility configured to generate power using geothermal energy as renewable energy may be controlled by the power generation control apparatus 34. A supply of renewable energy for controlling the geothermal power generation facility is an amount of geothermal energy, for example. For example, in the setting of the adjustment characteristic curve Cb (S7), a power controller adjusts the normal characteristic curve Ca to set the adjustment characteristic curve Cb when the amount of geothermal energy increases after an occurrence of fluctuation in the grid frequency F.

A wave power generation facility configured to generate power using wave energy as renewable energy may be controlled by the power generation control apparatus 34. A supply of renewable energy for controlling the wave power generation facility is an amplitude of a wave, for example. For example, in the setting of the adjustment characteristic curve Cb (S7), a power controller adjusts the normal characteristic curve Ca to set the adjustment characteristic curve Cb when the amplitude of a wave increases after an occurrence of fluctuation in the grid frequency F.

As will be understood from the examples described above, the power generation facility included in each of the plurality of power generation systems 30 is comprehensively described as a renewable energy power generation facility configured to generate power using renewable energy (such as solar energy, wind energy, geothermal power, or wave energy). It should be noted that a plurality of renewable energy power generation facilities having different power generation methods may be included in the power system 100.

### Supplemental Notes

For example, this disclosure is understood as follows based on the above descriptions.

A power system according to an aspect (a first aspect) of this disclosure includes a plurality of power generation systems capable of supplying power to a power grid, wherein each of the plurality of power generation systems includes a renewable energy power generation facility configured to generate power using renewable energy and a power generation controller configured to control, so as to follow a characteristic curve representative of a relationship between a stability indicator relating to stability of grid power in the power grid and power that is to be generated by the renewable energy power generation facility, the power that is to be generated by the renewable energy power generation facility in accordance with the stability indicator, and wherein the power generation controller is configured to adjust the characteristic curve in a direction that causes an increase in the power that is to be generated in a case in which a supply of renewable energy to the renewable energy power generation facility increases after an occurrence of fluctuation in the stability indicator.

Since the power that is to be generated by the renewable energy generation facility of each of the plurality of power generation systems is controlled in accordance with the stability indicator so as to follow the characteristic curve, it is possible to control the renewable energy generation facility of each of the plurality of power generation systems so as to substantially prevent a fluctuation in the stability indicator. In addition, in a power generation system receiving a supply of renewable energy that increases after the occurrence of the fluctuation in the stability indicator among the plurality of power generation systems, the characteristic curve is adjusted in the direction that causes an increase in the power to be generated. By adjustment of the characteristic curve, a shortage of power that is to be generated by a power generation system receiving a supply of renewable energy that decreases after the occurrence of the fluctuation in the stability indicator among the plurality of power generation systems is supplemented. Thus, in the entire power system constituted of the plurality of power generation systems, it is possible to reduce the probability of a shortage of power that is used to substantially prevent a fluctuation in the stability indicator.

In a specific example (a second aspect) of the first aspect, the power generation controller is configured to adjust the characteristic curve in the direction that causes an increase in the power that is to be generated by an adjustment amount corresponding to an amount of increase in the supply of renewable energy. According to the aspect described above, the characteristic curve is adjusted by the adjustment amount corresponding to an amount of increase in power due to an increase in the supply of renewable energy. Thus, it is possible to reduce the probability that the characteristic curve is excessively adjusted.

In a specific example (a third aspect) of the first aspect or the second aspect, the power generation controller is configured to adjust the characteristic curve in the direction that causes an increase in the power that is to be generated by an adjustment amount less than a total amount of reductions in power to be generated by one or more power generation systems receiving a supply of renewable energy that decreases after the occurrence of the fluctuation in the stability indicator, the reductions being due to the supply of renewable energy that decreases, the one or more power generation systems being among the plurality of power generation systems. According to the aspect described above, the characteristic curve is adjusted within a range up to the total amount of the reductions in power to be generated by the power generation systems receiving the supply of renewable energy that decreases. Thus, it is possible to reduce the probability that power that is to be supplied by the entire power system to the power grid is excessive. In other words, the entire power system can effectively reduce effects of fluctuation in a supply of renewable energy in a specific power generation system.

In a specific example (a fourth aspect) that is any one of the first aspect to the third aspect, the power generation controller is configured to notify a management system of a reduction in the power that is to be generated, the reduction being due to a decrease in the supply of renewable energy after the occurrence of the fluctuation in the stability indicator, and adjust the characteristic curve in the direction that causes an increase in the power that is to be generated by an adjustment amount indicated by a setting adjustment instruction from the management system. According to the aspect described above, a reduction in power that is to be generated by each of one or more power generation systems among the plurality of power generation systems is gathered to the management system. Thus, the power generation controller of each of the plurality of power generation systems is not required to recognize a reduction of power that is to be generated by another power generation system. In other words, it is possible to reduce load of processing executed by the power generation controller of each of the plurality of power generation systems.

In a specific example (a fifth aspect) that is any one of the first aspect to the third aspect, the power generation controller is configured to notify another power generation system of a reduction in the power that is to be generated, the reduction being due to a decrease in the supply of renewable energy after the occurrence of the fluctuation in the stability indicator, and adjust the characteristic curve in the direction that causes an increase in the power that is to be generated by an adjustment amount corresponding to a reduction notified by another power generation system among the plurality of power generation systems. According to the aspect described above, a reduction in power that is to be generated by each of one or more power generation systems among the plurality of power generation systems is shared by each of the plurality of power generation systems. Thus, a management system, which is configured to manage each of the plurality of power generation systems comprehensively, is not required to set the adjustment amount.

In a specific example (a sixth aspect) that is any one of the first aspect to the fifth aspect, the renewable energy power generation facility comprises a solar power generation facility configured to use solar energy as the renewable energy. In the solar power generation facility using solar energy as renewable energy, a supply of renewable energy (for example, an amount of solar radiation) is likely to change. Thus, this disclosure by which the characteristic curve is adjusted so as to reduce a shortage of power that is to be generated by the entire power system is particularly effective.

In a specific example (a seventh aspect) that is any one of the first aspect to the fifth aspect, the renewable energy power generation facility comprises a wind power generation facility configured to use wind energy as the renewable energy. In the wind power generation facility using wind energy as renewable energy, a supply of renewable energy (for example, an amount of wind energy) is likely to change. Thus, this disclosure by which the characteristic curve is adjusted so as to reduce a shortage of power that is to be generated by the entire power system is particularly effective.

A method for controlling a power system according to another aspect (an eighth aspect) of this disclosure is a method for controlling a power system including a plurality of renewable energy generation facilities capable of supplying power generated by use of renewable energy to a power grid, the method including, for a renewable energy power generation facility that is any one of the plurality of renewable energy power generation facilities, controlling, so as to follow a characteristic curve representative of a relationship between a stability indicator relating to stability of grid power in the power grid and power that is to be generated by the renewable energy power generation facility, the power that is to be generated by the renewable energy power generation facility in accordance with the stability indicator, wherein the controlling the power that is to be generated includes adjusting the characteristic curve in a direction that causes an increase in the power that is to be generated in a case in which a supply of renewable energy to the renewable energy power generation facility increases after an occurrence of fluctuation in the stability indicator.

### DESCRIPTION OF REFERENCE SIGNS

100... power system, 10... power grid, 20... management system, 30... power generation system, 31... solar power generation facility, 32... control system, 33... power conversion apparatus, 34... power generation control apparatus.

What is claimed is:

1. A power system comprising:
a plurality of power generation systems capable of supplying power to a power grid,
wherein each of the plurality of power generation systems includes:
a renewable energy power generation facility configured to generate power using renewable energy; and
a power generation controller configured to control, so as to follow a characteristic curve representative of a relationship between a stability indicator relating to stability of grid power in the power grid and power that is to be generated by the renewable energy power generation facility, the power that is to be generated by the renewable energy power generation facility in accordance with the stability indicator, and
wherein the power generation controller is configured to adjust the characteristic curve in a direction that causes an increase in the power that is to be generated in a case in which a supply of renewable energy to the renewable energy power generation facility increases after an occurrence of fluctuation in the stability indicator.

2. The power system according to claim 1, wherein the power generation controller is configured to adjust the characteristic curve in the direction that causes an increase in the power that is to be generated by an adjustment amount corresponding to an amount of increase in the supply of renewable energy.

3. The power system according to claim 1, wherein the power generation controller is configured to adjust the characteristic curve in the direction that causes an increase in the power that is to be generated by an adjustment amount less than a total amount of reductions in power to be generated by one or more power generation systems receiving a supply of renewable energy that decreases after the occurrence of the fluctuation in the stability indicator, the reductions being due to the supply of renewable energy that decreases, the one or more power generation systems being among the plurality of power generation systems.

4. The power system according to claim 1, wherein the power generation controller is configured to:
notify a management system of a reduction in the power that is to be generated, the reduction being due to a decrease in the supply of renewable energy after the occurrence of the fluctuation in the stability indicator; and
adjust the characteristic curve in the direction that causes an increase in the power that is to be generated by an adjustment amount indicated by a setting adjustment instruction from the management system.

5. The power system according to claim 1, wherein the power generation controller is configured to:
notify another power generation system of a reduction in the power that is to be generated, the reduction being due to a decrease in the supply of renewable energy after the occurrence of the fluctuation in the stability indicator; and
adjust the characteristic curve in the direction that causes an increase in the power that is to be generated by an adjustment amount corresponding to a reduction notified by another power generation system among the plurality of power generation systems.

6. The power system according to claim 1, wherein the renewable energy power generation facility comprises a solar power generation facility configured to use solar energy as the renewable energy.

7. The power system according to claim 1, wherein the renewable energy power generation facility comprises a wind power generation facility configured to use wind energy as the renewable energy.

8. A computer system implemented method for controlling a power system including a plurality of renewable energy generation facilities capable of supplying power generated by use of renewable energy to a power grid, the method comprising:
for a renewable energy power generation facility that is any one of the plurality of renewable energy power generation facilities, controlling, so as to follow a characteristic curve representative of a relationship between a stability indicator relating to stability of grid power in the power grid and power that is to be generated by the renewable energy power generation facility, the power that is to be generated by the renewable energy power generation facility in accordance with the stability indicator,
wherein the controlling the power that is to be generated includes:
adjusting the characteristic curve in a direction that causes an increase in the power that is to be generated in a case in which a supply of renewable energy to the renewable energy power generation facility increases after an occurrence of fluctuation in the stability indicator.
